(19) United States
(12) Patent Application Publication
(10) Pub. No.: US 2016/0269861 A1
(43) Pub. Date: Sep. 15, 2016

(54) METHOD AND DEVICE FOR VALIDATING USER BEHAVIOUR

(71) Applicant: KONINKLIJKE PHILIPS N.V., Eindhoven (NL)

(72) Inventors: Vincentius Paulus BUIL, Gennep (NL); Lucas Jacobus Franciscus GEURTS, Best (NL); Pei-Yin CHAO, Eindhoven (NL)

(21) Appl. No.: 15/033,922

(22) PCT Filed: Nov. 6, 2014
(86) PCT No.: PCT/EP2014/073851

§ 371 Date: May 3, 2016

(30) Foreign Application Priority Data
Nov. 20, 2013 (EP) 13193676.7

(51) Int. Cl. H04W 4/02; H04L 29/08; H04M 1/725

(52) U.S. Cl. CPC H04W 4/023; H04M 1/72527; H04M 1/72569; H04M 1/72572; H04L 67/22; H04M 2250/12

(57) ABSTRACT

An apparatus for validating a user behavior comprises a proximity detector (201) for detecting a proximity of a first device (101) to a second device (103), e.g. in response to the establishment of a short range communication, such as an NFC communication. A receiver (203) receives motion data from a motion detector with the motion data being indicative of a motion of the second device (103). An evaluator (209) evaluates whether the motion data meets a motion criterion or not. Finally, a designator (211) designates the user behavior as valid only if the motion data meets the motion criterion and the proximity of the first device to the second device is subsequently detected. Otherwise the user behavior may be designated as not valid. A processor (213) e.g. being part of one of the devices (101, 103) may perform differently dependent on whether the user behavior is designated as valid or not, e.g. different user notifications and feedback may be provided.

### FIELD OF THE INVENTION

The invention relates to validation of user behavior, and in particular, but not exclusively to evaluation of user behavior by personal electronic devices such as personal smartphones.

### BACKGROUND OF THE INVENTION

Electronic devices are increasingly becoming part of everyday life and is taking over or assisting in many functions and activities that previously were handled manually by the individual. For example, the mobile telephone is increasingly becoming a personal computation and communication device that may assist the user in many different daily functions. For example, a Smartphone may not only be used to provide communication but may also be used by the user for scheduling, planning and managing various activities.

In many scenarios, a personal device such as a smartphone may be used to retrieve, record and present various data from other devices which may be used by the individual. For example, electrical toothbrushes may comprise functionality for measuring e.g. the time spent brushing, the pressure applied etc. Such data may be transmitted to a smartphone e.g. using a Bluetooth or NFC communication link.

The increased variety and flexibility of user devices, applications and functions may however also result in more complex and complicated user operations that may be considered more challenging to a user. For example, specific operations or actions may be required by the user in order to establish a short range communication or allow the appropriate data to be presented. Accordingly, an increasingly complex user behavior may be required and it is accordingly desirable if the electronic devices can assist the user in performing the desired behavior.

Another trend in recent years has been an increased desire to use personal electronic devices to monitor, detect and record user behavior and characteristics. For example, the use of personalized health and exercise devices have become increasingly popular. For example, watches or smartphones capable of interfacing with exercise equipment or health monitoring devices in order to analyze and present information to the user is becoming increasingly popular. Thus, there is a growing trend towards electronic devices monitoring or evaluating user behavior

Accordingly, user activities are being supported by electronic devices that evaluate user behavior. Therefore, a continuing challenge in many scenarios is that of how to provide accurate evaluation of user behavior in order to assist the user.

Hence, an improved approach would be advantageous and in particular, an approach allowing for increased flexibility, improved accuracy, facilitated evaluation and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for validating a user behavior; the apparatus comprising: a proximity detector for detecting a proximity of a first device to a second device; a receiver for receiving motion data from a motion detector, the motion data being indicative of a motion of the second device; an evaluator for evaluating if the motion data meets a motion criterion; and a designator for designating the user behavior as valid only if the motion data meets the motion criterion and the proximity of the first device to the second device is subsequently detected, a user interface for generating a user output in response to whether the motion data meets the motion criterion within a given time interval or not.

The invention may allow an improved approach for evaluating user behavior and may in many applications or scenarios provide improved accuracy and/or new or improved approaches for evaluating user behavior. The approach may for example allow new or improved detection, monitoring or categorization of individual user actions in many embodiments and scenarios. The approach may in particular allow evaluation of the use and possible interaction of different devices to provide additional information on user behavior thereby allowing an improved estimation of this. In particular, the combined consideration of proximity between devices and e.g. movement patterns of at least one of the devices may provide data and information that is particularly suitable for detecting or evaluating many different user behaviors or actions.

For example, the approach may be used to estimate whether users correctly perform requested actions required to establish communication links, whether a user adheres to a prescribed medicine taking program, etc.

The designator may designate the user behavior as invalid if the motion data does not meet the motion criterion, or if the proximity of the first device to the second device is not subsequently detected (or both).

The detection of the proximity of the first device to the second device may specifically be required to occur within a time interval following a time for which the motion data meets the motion criterion, i.e. within a time interval determined relative to the time for which the motion data indicates that the second device has performed a movement required to meet the motion criterion. In many embodiments, the designator may only designate the user behavior as valid if a proximity of the first device to the second device is detected in a time interval determined relative to a time of the motion data meeting the motion criterion. The time interval may start at the time of the motion data meeting the motion criterion and continue for a predetermined duration. This time interval may often have a relatively short duration, such as specifically a duration of no more than 5, 2, 1 or ½ minutes.

The approach may provide particularly advantageous operation in many scenarios that include movement of a device in order to initialize an operation. The detection of the movement by the motion data meeting the motion criterion may for example evaluate whether a user performs an action which may be associated with bringing the first and second devices close to each other. If the detected movement results in a proximity detection, it may be considered that the expected user behavior/action has been successfully completed. Otherwise, it may indicate that the user has attempted to perform an action, but has not been successful. If no motion data meeting the motion criterion is received, it may e.g. be concluded that the user has not attempted the required or expected behavior or action, even if proximity between the devices is detected.

The generation of a user output in response to whether the motion data meets the motion criterion within a given time interval (or not) may in particular provide improved user behavior evaluation in many scenarios, and may allow improved and/or new applications or functions to be employed. In many embodiments, the approach may provide an increased reliability in estimating whether the user has performed a specific user action in a timely manner. The specific consideration of the user movement within a time interval may provide a particularly advantageous differentiation between different user behaviors that may be highly suitable for generating a dedicated user feedback, which e.g. may be used to guide the user. For example, it may allow differentiation between a user attempting to perform a given action (e.g. coupling two communication units by bringing them together) and a user not attempting to perform such an action. The user feedback may be adapted accordingly.

The user interface may specifically generate different user notifications dependent on whether the motion data meets the motion criterion or not within the given time interval.

The time interval may often have a relatively short duration, such as specifically a duration of no more than 5, 2, 1 or ½ minutes.

The motion data meeting the motion criterion may specifically be an indication of an initializing user action for achieving proximity of the first device to the second device, such as a movement to bring the devices together.

In some embodiments the apparatus may comprise a determiner for determining the motion criterion as a motion criterion for the second device, e.g. in response to an identification (e.g. type, manufacturer, or individual device identification) of the second device. For example, motion criteria may be stored for different devices and the determiner may be arranged to select a motion criteria suitable for the specific second device.

The proximity of the first and second devices is detected when a proximity requirement is met. Any suitable proximity requirement may be used, and it is not necessary for this to directly correspond to any specific physical distance or physical property of the devices. Specifically, any proximity criterion for which the probability of the criterion being met is higher for devices closer to each other than farther from each other may be used.

However, in some embodiments, a proximity detection is indicative of the first and second devices being no more than 1 meter, and often advantageously 50 cm from each other.

The motion detector may be part of the second device, and may for example be or comprise one or more accelerometers, compasses, GPS receivers etc. The motion data is indicative of a motion/movement of the second device (possibly (only) an orientation or rotation). The motion data may be absolute or relative data.

The motion criterion may reflect an expected movement of the second device when performing a valid user behavior/act.

A processor, e.g. being part of one of the devices, may adapt a processing in dependence on whether the user behavior is designated as valid or not, e.g. different user notifications and user feedback may be provided, or different functions or processes may be performed.

In many embodiments, the motion criterion may comprise a requirement that the motion data corresponds to a given motion pattern.

This may provide improved user behavior evaluation in many embodiments. In particular, it may in many scenarios allow an accurate estimation of a user action or movement.

The motion (including e.g. an orientation) pattern may for example describe a range or set of positions as a function of time (where the time may be an absolute or, more typically, a relative time). The positions may be given as intervals of positions, e.g. indicating how closely the motion data must match the expected motion in order for the motion criterion to be considered to be met. The positions may be absolute or relative positions.

The second device may be any user moveable device, including for example a smart phone, a smart watch, a toothbrush etc. In some embodiments, the first device may be a stationary device and may specifically be a non-user moveable device, i.e. one that is not intended to be moved by the user during operation. In many embodiments, no movement data for the first device is used in the evaluation or the designation of the user behavior. In other embodiments, the first device may also be a user moveable device, and in some embodiments motion data for the first device may also be taken into account when evaluating if the motion data meets the motion criterion and/or when designating the user behavior.

The motion data may be indicative of a user motion, and may specifically be indicative of hand movement of a user.

In accordance with an optional feature of the invention, the first device and the second device comprises communication units; and the proximity detector is arranged to detect the proximity of the first device to the second device in response to an establishment of a communication between the communication units.

This may provide an advantageous proximity detection, and in particular the system may allow the user behavior evaluation to be closely linked to the communication operation of the devices. Thus, such a proximity detection may not only provide information on whether the devices are close to each other, but may also be indicative of functionality of the devices.

The communication units may specifically be short range communication units, e.g. having a range of no more than 50 cm. For example, the short range communication units may be NFC communication units.

In accordance with an optional feature of the invention, the second device comprises a motion sensor for generating the motion data, and the second device further comprises the proximity detector, the receiver, the evaluator and the designator.

In many embodiments, a user moveable device may be used to evaluate the user behavior based on the movement of the device. The approach may in particular provide additional or enhanced user functionality from a user device. For example, additional functionality may be provided by a user's own mobile phone, smartphone or smart watch. In many embodiments and scenarios, an enhanced user experience may be achieved.

In some embodiments, the second device further comprises a user interface for generating a user output in response to whether the user behavior is designated as valid or not.

In accordance with an optional feature of the invention, the first device comprises the proximity detector, the receiver, the evaluator and the designator.

The approach may allow a device to evaluate user behavior based on the movement of another device. For example, a stationary device may be equipped to evaluate the user behavior based on a user moveable device. The motion data may be e.g. be received via a wireless communication link.

The approach may also in many embodiments allow e.g. a non-user specific device, such as e.g. a payment terminal, to evaluate user behavior based on the movement of the user's own devices.

Thus, enhanced, improved or additional functionality can be achieved in many embodiments.

In some embodiments, the first device further comprises a user interface for generating a user output in response to whether the user behavior is designated as valid.

In accordance with an optional feature of the invention, the apparatus further comprises a user output for outputting a request for a user to perform a user action to bring the first device into proximity with the second device; and wherein the evaluator is arranged to determine the motion criterion as a motion criterion associated with the user action.

The approach may provide a particularly advantageous approach for e.g. an application in which a user is guided or instructed to perform specific actions that result in or includes devices being brought together, and to verify whether indeed these user actions are performed. The approach may provide an advantageous user experience, and may e.g. assist users in performing necessary actions for achieving a desired overall function or usage.

In accordance with an optional feature of the invention, the designator is arranged to designate the user behavior as valid only if the motion data meets the motion criterion within a first time interval relative to a timing of the outputting the request.

The approach may provide improved user experience in many embodiments, and specifically a very close connection between providing guidance information and confirming the corresponding user behaviour or actions can be achieved. The first time interval may start substantially at the same time as the request is output.

The first time interval may often have a relatively short duration, such as specifically a duration of no more than 5, 2, 1 or ½ minutes.

In accordance with an optional feature of the invention, the apparatus further comprises a user interface for generating a user output in response to whether proximity of the first device to the second device is detected within a given time interval.

The approach may provide improved user behavior evaluation in many scenarios, and may allow improved and/or new applications or functions to be adopted. In many embodiments, the approach may provide an increased reliability in estimating whether the user has performed a specific user action in a timely manner.

The user interface may specifically generate different user notifications dependent on whether proximity of the first device to the second device is detected within the given time interval or not.

In some embodiments, different user feedback/notifications may be generated for the different combinations of the motion data meeting the motion requirement and the proximity of the first device to the second device being detected within the given time interval.

In accordance with an optional feature of the invention, the proximity detector is arranged to detect the proximity of the first device to the second device in response to a detection of a level of an electromagnetic signal from at least one of the first device and the second device exceeding a detection threshold.

This may provide an advantageous proximity detection, and may in many embodiments allow the user behavior evaluation to be closely linked to the communication operation of the devices. It may in particular allow the proximity detection to be based on a communication system having a communication range which exceeds the range desired for the proximity detection. For example, proximity detections in the order of 50 cm may be based on e.g. a Bluetooth communication with a range of several meters.

The electromagnetic signal may specifically be a communication signal, such as a (possibly modulated) carrier of a radio communication signal.

In some embodiments, the motion criterion comprises a requirement that the motion data matches a motion requirement within a time interval.

The requirement may specifically be that the motion data must be consistent with a specific user movement having been made within the given time interval.

The approach may provide improved user behavior evaluation in many scenarios, and may allow improved and/or new applications or functions to be adopted.

In accordance with an optional feature of the invention, the motion criterion comprises a requirement of the detection of the proximity of the first device to the second device occurring within a time interval relative to the motion data corresponding to a motion pattern of the second device.

The approach may provide improved user behavior evaluation in many scenarios, and may allow improved and/or new applications or functions to be adopted. In many embodiments, the approach may provide an increased reliability in estimating whether the user has performed a specific user action in a timely manner.

In accordance with an optional feature of the invention, the apparatus further comprises a controller for determining a time interval in which the motion data must meet the motion criterion, and the proximity of the first device to the second device must be detected for the user behavior to be designated valid.

The approach may provide improved user behavior evaluation in many scenarios, and may allow improved and/or new applications or functions to be adopted. In many embodiments, the approach may provide an increased reliability in estimating whether the user has performed a specific user action in a timely manner.

In accordance with an optional feature of the invention, the apparatus further comprises a user interface arranged to generate a user notification if the motion data meets the motion criterion within the time interval but no proximity of the first device to the second device is detected.

The approach may provide improved user behavior evaluation in many scenarios, and may allow improved and/or new applications or functions to be adopted. In many embodiments, the approach may provide an increased usability and may allow an improved assistance and guidance to be provided to a user thereby assisting the user in performing a desired operation.

In some embodiments, the apparatus further comprises a user interface arranged to generate different user notifications in response to which combination of the following criteria is met within the time interval:
the motion data meeting the motion criterion within the time interval (or not), and
proximity of the first device to the second device being detected (or not).

In some embodiments, the apparatus further comprises a user interface arranged to generate different user notifications if the motion data meets the motion criterion within the time interval but no proximity of the first device to the second device is detected than if the motion data does not meet the motion criterion within the time interval.

The approach may provide improved user behavior evaluation in many scenarios, and may allow improved and/or new applications or functions to be adopted. In many embodiments, the approach may provide an increased usability and may allow an improved assistance and guidance to be provided to a user thereby assisting the user in performing a desired operation.

If the motion data does not meet the motion criterion within the time interval, the user interface may be arranged to generate different user notifications dependent on whether a proximity of the first device to the second device has been detected or not.

In accordance with an optional feature of the invention, the apparatus further comprises a receiver for receiving operational data from at least one of the first device and the second device, and wherein the designator is arranged to designate the user behavior as valid only if the operational data meets a criterion.

The approach may provide improved user behavior evaluation in many scenarios. In particular, it may in many embodiments provide a more accurate detection of whether the user has performed a given action or not.

In accordance with an optional feature of the invention, the motion data comprises orientation data indicative of an orientation of at least one of the first device and the second device; and the motion criterion includes a requirement that the orientation data meets a criterion.

The approach may provide improved user behavior evaluation in many scenarios. In particular, it may in many embodiments provide a more accurate determination of whether the user has performed a desired operation or action in order to establish a communication, such as for example an NFC communication.

In some embodiments, at least one of the first device and the second devices is arranged to execute an operation in dependence on whether the user behavior is designated valid or not.

The approach may allow an improved adaptability of a system to the specific user behavior. For example, guidance or user feedback specifically adapted to the user's behavior may be provided.

In accordance with an optional feature of the invention, the designator is further arranged to designate the user behavior as valid only if the motion data meets a further motion criterion comprising a requirement for motion of the second device in a time interval following a detection of proximity of the first device to the second device.

This may provide improved evaluation of user behavior and may in particular allow a determination based on more complex operations requiring a specific sequence between multiple actions, including actions before and after the first and second devices being brought into proximity with each other.

In accordance with an optional feature of the invention, the motion data is indicative of a motion of both the first device and the second device and the motion criterion comprises a requirement for motion of the first device and motion of the second device.

The approach may provide improved user behavior evaluation in many scenarios.

According to an aspect of the invention there is provided method of validating a user behavior; the method comprising: detecting a proximity of a first device to a second device; receiving motion data from a motion detector, the motion data being indicative of a motion of the second device; evaluating if the motion data meets a motion criterion; and designating the user behavior as valid only if the motion data meets the motion criterion and the proximity of the first device to the second device is subsequently detected.

According to an aspect of the invention there is provided a computer program product comprising computer program code means adapted to perform all the steps of the above method when said program is run on a computer.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a scenario in accordance with some embodiments of the invention;

FIG. 2 illustrates an example of some elements of an apparatus for validating a user behavior in accordance with some embodiments of the invention;

FIG. 3 illustrates an example of a flow chart of an exemplary method of validating a user behavior in accordance with some embodiments of the invention; and

FIG. 4 illustrates an example of a flow chart of an exemplary method of validating a user behavior in accordance with some embodiments of the invention.

### DETAILED DESCRIPTION OF SOME EMBODIMENTS OF THE INVENTION

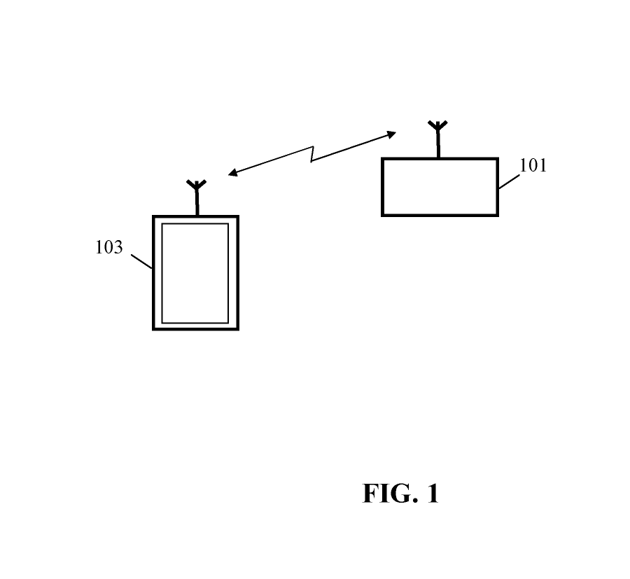

FIG. 1 illustrates an example of a scenario in accordance with some embodiments of the invention. In the example, a first device 101 and a second device 103 are used by a user in connection with a user activity. One device may for example be a personal device, such as a smartphone, and the other device may for example be a function specific device, such as a medical device or a personal hygiene device.

In the scenario, at least the second device 103 is a mobile device that is user moveable, i.e. it may be moved by user. It may for example by a smart phone or a smart watch. In many embodiments, the first device 101 may be a static device such as for example a payment terminal or a static pill box/dispenser. In other embodiments, the first device 101 may also be user moveable and may for example be a toothbrush or another smart phone.

In the scenario, the user is expected to perform a specific action and an apparatus may be used which includes functionality for detecting whether the user performs this action or not. Thus, the apparatus may be arrange to estimate whether the user performs an action or not. The apparatus is specifically arranged to designate a user behavior as valid or not valid. A valid user behavior may be considered to correspond to an estimate of the user performing the intended or expected action or activity and a non-valid user behavior may correspond to an estimate that the user does not perform the intended or expected user action or activity.

The apparatus is specifically arranged to designate the user behavior as valid or invalid dependent on whether at least the second device 103 performing a motion that matches a given criterion for the expected user behavior, and that a proximity of the first and second devices is subsequently detected.

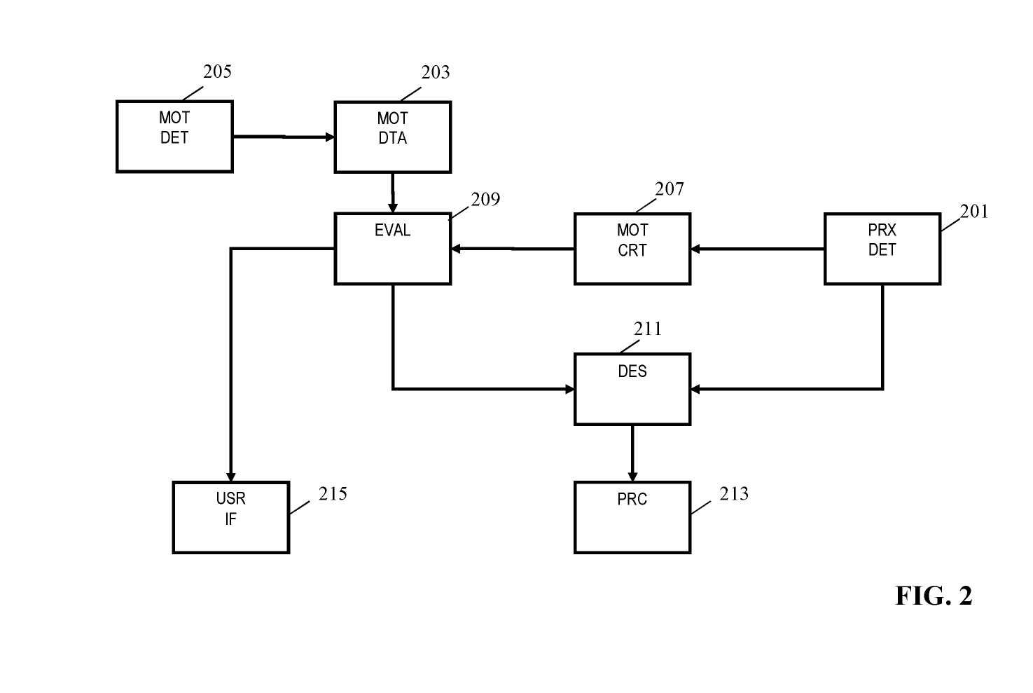

FIG. 2 illustrates an example of some elements of an apparatus for validating a user behavior in the scenario of FIG. 1.

The apparatus comprises a proximity detector 201 for detecting a proximity between the first device 101 and the second device 103. The proximity is detected when a proximity criterion is met. It will be appreciated that any suitable criterion may be used and indeed that different signals and properties may be used to detect the proximity in different embodiments. It should also be appreciated that it is not essential that the proximity is detected as corresponding to a distance between the devices e.g. being less than a specific threshold or that it reflects any specific determinable physical distance. Rather, the criterion may be any criterion that is considered to reflect a likelihood that the devices are close to each other. Thus, the proximity detection does not necessarily detect that the devices are less than a specific threshold distance apart but may simply reflect that a criterion which reflects an increased likelihood of the devices being closer rather than farther apart may be used.

The proximity detection may for example be based on physical measurements (e.g. physical contact), electromagnetic signal measurements (e.g. a signal strength of a signal radiated from one of the devices and received by the other), optical detections (e.g. an image object estimated to correspond to a device being larger than a given value etc.), or any other suitable property.

The apparatus further comprises a motion data receiver 203 receiving motion data from a motion detector/sensor 205. The motion data is indicative of a motion/movement of the second device 103 and the motion detector/sensor is part of the second device 103 and generates data reflecting how this is moved. In cases where the motion data receiver 203 is not comprised in the second device 103, the motion data receiver 203 may receive the motion data through a suitable communication means, such as e.g. a direct radio communication link between the motion detector/sensor 205 and the motion data receiver 203.

The apparatus further comprises a motion criterion processor 207 which is coupled to the proximity detector 201. The motion criterion processor 207 is arranged to determine a motion criterion associated with the second device 103. The motion criterion may specifically reflect a motion or movement of the second device 103 which is associated with the expected or desired user behavior. Specifically, if the user behavior corresponds to what is to be considered a valid user behavior, the user is expected to move the second device 103 such that the motion criterion is met motion detector/sensor 205. Thus, the motion criterion may be constructed such that if the second device 103 performs a movement meeting the criterion, then this movement is considered to be consistent with the expected movement by the user.

The motion criterion is related to the second device 105 and may typically be specific to at least one of the first and second devices 103, 105. Indeed, in many embodiments, the motion criterion processor 207 may be arranged to determine the motion criterion when an identity or type of the first and/or second device 103, 105 are known.

The motion criterion processor 207 is further coupled to an evaluator 209 which is further coupled to the motion data receiver 203. The evaluator 209 receives the motion data and the motion criterion and proceeds to evaluate if the motion data meets the motion criterion.

It will be appreciated that the evaluation and indeed the format of the motion data and the motion criterion will depend on the preferences and requirements of the individual embodiments. In many embodiments, the motion criterion will define a set of motion data which is considered to be consistent with a given desired motion/movement. If the motion data falls within this defined set of data, the criterion is considered to be met and otherwise it is considered not to be met.

An example of a motion criterion would be a requirement that the second device has to be moved by at least a given distance along a given direction within a given time interval. It will be appreciate that many other motion criteria can be used, including for example simply a criterion that a degree of motion has to exceed a given level within a given time interval.

The motion data may in some embodiments be the full raw motion data generated by a motion sensor, such as the motion (including possibly orientation) data generated by an accelerometer or a GPS receiver. In other embodiments, the motion data may be a compressed or processed indication of the motion of the second device 103, such as for example an indication of the movement along a given direction within a given time interval.

The evaluator 209 thus evaluates whether the motion data originating at a motion sensor in the second device 103 corresponds to the expected movement as indicated by the motion criterion. Thus, the evaluation may be used as an indication of whether the user has performed the expected user action by moving the second device 103 in a way that is consistent with the expected user action.

The apparatus additionally comprises a designator 211 which is coupled to the evaluator 209 and to the proximity detector 201. The designator 211 receives data reflecting the result of the evaluation made by the evaluator 209 and data indicative of the result of the proximity detection, and specifically an indication of whether a proximity between the first device 101 and the second device 103 has been detected.

The designator 211 is arranged to use both of these results to determine whether the user behavior is considered valid or not. Specifically, the designator 211 may generate an estimate of whether the user has performed the expected or desired operation or whether the user has not performed the expected or desired operation. The designator 211 proceeds to designate the user behavior as valid only if the motion data meets the motion criterion and the proximity of the first device to the second device is subsequently detected, i.e. only if the desired motion has been detected first and subsequently the proximity has been detected. If this is not the case, the user behavior may be considered as invalid. Thus, the user behaviour is considered valid if the motion criterion is met prior to the proximity detection, and thus typically a determination of the user behaviour as valid corresponds to a detection of a user motion that has resulted in the two devices 101, 103 being proximal.

Thus, the designator 211 may generate an estimate of whether a user has performed a given action. If so, the user behavior is designated valid, and otherwise it may be designated as invalid. It will be appreciated that further subdivisions of the categories of valid and not valid may be used in some embodiments.

As mentioned, the designator 211 determines the user behavior as valid only if the correct order of the detections of the motion data meeting the motion criterion and of the proximity of the devices 101, 103 occurs. Thus, the motion requirement may typically correspond to a movement that is expected to be performed by a user prior to establishing proximity. Indeed, the movement may typically be one which is associated with a user action that is expected for the user when he seeks to bring the two devices 101, 103 proximal to each other. For example, the motion criterion may reflect a movement of the second device 103 which the user is expected to perform when he is instructed (or expected) to bring the second device 103 into contact with the first device 101.

In many embodiments, the motion requirement is thus indicative of an expected movement that the user should make with the second device 103 in order to bring this into contact with the first device 101. The detection of the motion data meeting the motion criterion may accordingly indicate that the user is now attempting to bring the two devices together, e.g. to establish an NFC communication connection, and the detection of whether this movement results in the expected proximity may indicate whether the user has performed the operation successfully or not. Thus, the detection of the motion criterion being met may be considered as an initializing event which indicates that a proximity detection is expected within a given time interval.

Similarly, if proximity is detected without a previous detection of the motion criterion being met, this may indicate that the proximity is not a result of the expected user behavior, and thus the system may e.g. adapt operation accordingly. For example, the approach may be used to differentiate between scenarios where devices merely happen to be proximal to each other (e.g. by just coincidentally being put next to each other on a table or in a drawer), and scenarios where a user has actively brought the first device proximal to the second device.

In the example, the designator 211 is coupled to a processor 213 which is arranged to adapt a processing in response to whether the user behavior is designated as valid or not. Specifically, different processes may be executed, the functionality of a process may be adapted and/or different user outputs may be generated in dependence on the designation of the user behavior.

It has been found that in many applications and scenarios, the combination of the motion evaluation and subsequent proximity detection provides a very efficient estimation of user behavior that may be beneficial in many scenarios.

Indeed, as electronic devices are increasingly used to assist users in various behaviors, the approach allows a very efficient determination of user behavior that may further e.g. assist the user or the monitoring of the user.

The system furthermore comprises a user interface 215 which specifically can generate a user output. For example, the user interface 215 may comprise a display and/or a sound output that can provide information and notifications to a user.

The user interface 215 may furthermore comprise processing functionality for determining a suitable user output and rendering this. In the example, the user interface 215 is coupled to the evaluator 209 and is provided with information of whether the motion data meets the motion criterion. Specifically, when the evaluator 209 detects that motion data has met the criterion, it may send a notification of this to the user interface 215.

The user user interface 215 is arranged to generate a user output in response to whether the motion data meets the motion criterion within a given time interval (or not). Thus, the user interface 215 may evaluate whether the motion criterion has been met within a given time interval. The user interface 215 may then generate different user outputs depending on whether this is the case or not. For example, if the user criterion is met within the time interval, no user output is generated, but if it is not met, a user output providing guidance or directions for bringing the devices 101, 103 together may be provided.

Thus, if the criterion is met within the time interval, a first user output may be selected for rendering by the user interface 215 (including possibly a null user output corresponding to no rendering). If not, a different user output may be selected (including possibly a null user output corresponding to no rendering). The user interface 215 may then generate the selected user output. Thus, the rendered user output will be different when the criterion is met within the time interval than if it is not met within the time interval.

For example, if an application running on a mobile phone (corresponding to the second device 103) requests the user to establish an NFC connection by bringing the mobile phone close to another device, the mobile phone may proceed to evaluate if the user performs a movement with the mobile device corresponding to the expected movement when bringing the two devices close. If so, it may provide feedback reflecting that the user has attempted to make the connection (e.g. providing more specific guidance if the communication setup was not successful) and otherwise it may generate another user notification requesting that the devices are brought together.

The user interface 215 may generate a user output which does not necessarily depend on whether proximity has been detected. Indeed, in some embodiments, the user interface 215 may generate a user output as soon as the motion criterion has been met indicating that the expected motion has been performed. It may then wait for the proximity to be detected. In contrast, if no valid motion detection has occurred by the end of a given time interval, the user interface 215 may e.g. refrain from generating a user output, may indicate that the process has failed, or e.g. provide instructions to the user on how to bring the two devices together.

The approach may thus provide for an improved user experience wherein the user may e.g. be provided with additional information on how the process is progressing and/or with additional guidance when required. Thus, the approach may not only detect a valid user behaviour but may also assist the user in performing the desired user behaviour with the assistance being adapted based on the actual user behaviour.

The given time interval may be determined in different ways in different embodiments. For example, in some embodiments, the time interval may be determined by a timer of fixed duration being started in response to an event. If the criterion is met before the timer expires, it is considered that this detection has occurred within the time interval. If not, it is considered that the motion criterion has not been met within the time interval.

The event starting the time interval may for example be a user input. For example, it may be a user input which initiates the process that requires the two devices to be brought together. For example, a user may press a button indicating that he wants to establish an NFC connection with another device. This user input may start the timer, and if no motion corresponding to the motion criterion is received before the timer times out, the user interface 215 may e.g. proceed to output information guiding the user towards establishing an NFC connection. As another example, the user may start an application that requires the devices to be brought close to each other. The time interval may be determined in response to the initialization of the application, e.g. the timer may be started when the application is started e.g. by the user.

As another example, the time interval may be initialised by an application generating a suitable indication. For example, if an application is running, it may at some stage determine that it is required for the device to be brought close to another device. It may then transmit a request to the user interface 215 that this outputs a message requesting the user to bring the two devices close to each other. At the same time, the user interface 215 may start the timer defining a time interval in which it is expected that the desired motion is performed.

In many examples, the duration of the time interval may be predetermined. Thus, whereas the start time may in many embodiments may be event driven, the duration may often be predetermined. However, it will be appreciated that in other embodiments, the duration may also be event driven, or in other ways dependent on the current scenario and characteristics.

In some embodiments, the time interval may be dependent on the proximity detection. For example, the end of the time interval may be dependent on a detection of proximity. E.g, a timer with a predetermined duration may be started in response to an event. The user interface 215 may then determine whether the motion criterion is met within a given time interval. If this is the case, the user interface 215 may not generate any user output (but e.g. wait for the proximity detection). If no motion detection has occurred by the end of the interval, the user interface 215 may instead proceed to generate a user output with specific instructions on how to bring the two devices together in an appropriate way. In addition, if proximity detection occurs during the time interval but before any appropriate motion detection, the user interface 215 may end the time interval and proceed to generate a user output with specific instructions. This may for example reflect that the proximity between the devices has not been achieve in the desired way.

The selection of a suitable time interval may depend on the preferences and requirements of the individual embodiment. Typically, the time interval may have a duration that is relatively short. Indeed, the approach may specifically be useful for detecting user behaviour of relatively short duration and which is expected within relative short time intervals (typically in the orders of less than 10 minutes). For example, the approach may be particularly suitable for detecting user actions that are expected to occur within a short time interval of an initiating event, such as within a short interval of the user interface 215 generating a request for the devices to be brought together. In many embodiments, the time interval may have a duration which does not exceed 5 minutes, 2 minutes, 1 minute or e.g. 30 seconds. Thus, the described approach is particularly suited for validating short term user behaviour and specific user actions.

In many embodiments, the user interface 215 may be arranged to output a request for the user to perform a user action to bring a first device into proximity with a second device. For example, the display of the user interface 215 may display a message requesting that the user brings the two devices into contact with each other.

The evaluator 209 may further proceed to determine the motion criterion for this user action. For example, the evaluator 209 may comprise a set of a plurality of motion criterions associated with different requests, for example depending on which devices are involved. E.g., one motion criterion may be stored for bringing a mobile phone into contact with the user's toothbrush, another for bringing it into contact with a pill dispenser etc. Depending on current application, different user actions may thus be expected and accordingly the evaluator 209 may be arranged to select the appropriate motion criterion for the current application/ expected user action.

In some cases, the evaluator may only have one available motion criterion, i.e. the same motion criterion may always be used/selected.

In many embodiments, the designator 211 may be arranged to designate the user behavior as valid only if the motion data meets the motion criterion within a first time interval relative to a timing of the outputting the request.

Specifically, it may be required that the detection of appropriate motion happens within a given duration from the user being requested to perform the action. If the movement has not been detected within this duration, it may be considered that the process has failed. In this case, the designator 211 may indicate an invalid user behaviour and the system may proceed accordingly.

Similarly to the time interval for determining which user output to generate, the time interval in which the motion criterion must be met in order for the user behaviour to be designated as valid, and specifically for such a time interval following a user request, may depend on the preferences and requirements of the individual embodiment. Typically, such a time interval may have a duration that is relatively short. Indeed, the approach may specifically be useful for detecting user behaviour of relatively short duration and which is expected within relative short time intervals. For example, the approach may be particularly suitable for detecting user actions that are expected to occur within a short time interval of an initiating event, such as within a short interval of the user interface 215 generating a request for the devices to be brought together. In many embodiments, the time interval may have a duration which does not exceed 5 minutes, 2 minutes, 1 minute or e.g. 30 seconds. Thus, the described approach is particularly suited for validating short term user behaviour and specific user actions.

The apparatus of FIG. 2 may be implemented fully or partially in the first device 101, fully or partially in the second device 103, or e.g. fully or partially in one or more other devices.

Indeed, each feature may individually be implemented in the first device 101, the second device 103 or in one or more other devices, or may indeed be distributed across a plurality of devices. In scenarios wherein two functional features that are coupled together are in different physical devices (or indeed where one functional feature is distributed across a plurality of devices), the devices may communicate the necessary data e.g. using a suitable wireless communication link.

For example, in some embodiments, the first device 101 may be a smartphone device that comprises all elements of the apparatus of FIG. 1 except for the motion detector 205. The smartphone may then determine that a user behavior is valid if the smartphone is close to the second device 103 after the user has moved the second device 103 as expected. As another example, the second device 103 may be a smartphone device that comprises all elements of the apparatus of FIG. 1 including the motion detector 205. The smartphone may then determine that a user behavior is valid if the smartphone is close to the second device 103 after the user has moved the smartphone as expected. As another example, a third device may comprise all parts of the apparatus except the motion detector 205. It may e.g. receive data from both the first device 101 and the second device 103 which indicates whether a short range communication link has been established between these. If so, the proximity detector 201 in the third device may consider that the first device 101 is indeed proximal to the second device 103 and it may proceed to determine that this has occurred a short time after motion data received from the motion detector 205 has met the motion criterion. If so, the user behavior is designated as valid.

In order to further illustrate the approaches, some very specific examples of applications and implementations will be described in the following.

The examples are based on the realization that many things may go wrong when people need to perform a physical sequence of actions to perform a task involving electronic devices. The examples use sensor information from the involved devices to provide information that can be evaluated to determine whether a user action is performed the right way, and if not what might have gone wrong. The approach seeks to detect sequential events with respect to the proximity of two devices, and the motion of at least one of these devices in order to evaluate the user behavior.

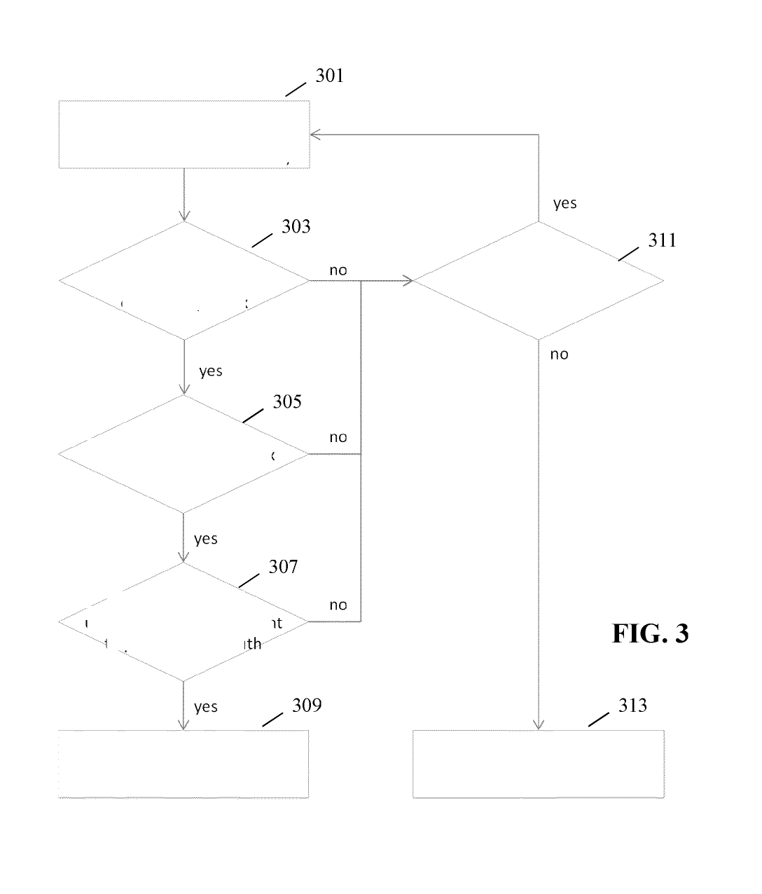

The first example is aimed at improving and measuring medication adherence, i.e. to monitor whether it is likely that a user takes his medicine as prescribed. The problem with measuring medication adherence is that it is difficult to measure actual intake of medication. The approach described in the following may assist in checking whether a patient has taken his medication. In the example, the second device is a smart watch with a motion sensor and the first device is an electronic pill box. Both devices are equipped with close range communication means such as e.g. Bluetooth, body-coupled communication, ANT, NFC, or Zigbee. The range of the networking system may be tuned to a range of around 0.5 m to provide a proximity indication (unless body-coupled communication is used, which works on the basis of touch). Thus, in the example, the establishment of a close range communication link is considered to correspond to a detection of a proximity between the devices. In the example, the functionality of the apparatus of FIG. 2 is implemented in a smart watch, i.e. in the example the second device 103 is a smart watch (i.e. a watch with computational functionality). The smart watch executes the method of FIG. 3 in order to estimate whether the user has taken his medication or not.

In step 301, the system determines that it is time for the user to take certain medication and the smart watch and/or electronic pillbox starts waiting for the user to interact with the pillbox. Optionally this may be communicated to the user via a reminder message on the smart watch (e.g. communicated via a wireless network such as WiFi) and/or pillbox.

Next, a three stage check is performed in order to estimate whether the user actually took the medication.

In step 303, the system proceeds to estimate whether the user has performed, within a certain time period, a motion consistent with the user moving his wrist, and thus the smart watch/second device 103, towards the pill box. The movement may for example be a simple movement of the hand performing a forwards and backwards movement, i.e. the motion requirement may be a requirement that the user performs a movement that includes moving the wrist e.g. at least 10 cm in a direction, followed by a short pause (say from 1-10 seconds), followed by a movement back. If so, it may be considered that the user is likely to have made an attempt to access the pill box.

In step 305, it is evaluated whether the user has indeed managed to approach the electronic pillbox within a certain time period X. This is determined to be the case if a proximity between the smart watch and the pill box (i.e. the first and second device) is detected by the smart watch. This may specifically be detected by a proximity detector 201 comprised in the smart watch detecting a signal level from a communication carrier of the pillbox exceeding a given threshold. This may determine with a high probability that it is the patient himself operating the pillbox, and not anyone else.

In some embodiments, the approach may include an additional optional test to detect if correct operational data indicative of an expected operation has been received from the pill box. Specifically, if a proximity is detected, the smart watch may proceed to estimate whether the user has taken the medication from the electronic pillbox within a certain time period Y from the proximity detection by evaluation operational data from the pill box. Specifically, this may be considered to be the case if a signal is received from the pill bock indicating that an action has been taken with respect to the pill box. For example, a sensor in the form of a movement detector on the lid(s), weight sensors in the different pockets that contain the pills, etc. may provide an indication that a desired action has been performed. This may determine with a high probability that the patient's hand contains medication.

If this requirement is met, or following step 305 if the optional operational data check is not included, the system in the specific example of FIG. 3 proceeds in step 307 to estimate whether the user has performed, within a certain time period Z, a second motion consistent with the user putting the medication in his mouth. This is determined by detecting whether the hand has been moved towards the mouth which is considered to be the case if the motion data from a motion sensor in the smart watch meets a motion data requirement that reflects a movement of the hand towards the mouth.

Thus, in the example, a second motion test is performed and thus the motion criterion in this specific example comprises both a requirement for the motion data before the proximity detection and a requirement for the motion data after the proximity (or equivalently the validation check includes two motion criteria with one relating to a time prior to the proximity detection and one relating to a time after the proximity detection. Thus, in the specific example, expected movement is required both before and after the pill box is accessed.

If the three stage check is successful, i.e. all three tests are met, then it is highly probable that the medication was taken by the user, and this can then be registered by the smart watch, and e.g. communicated to other systems if desired. Thus, if step 307 is also positively met, the method proceeds to step 309 wherein the user behavior is designated as valid thereby indicating that the medication has been taken.

If any of the three tests have failed, the method skips to step 311 wherein it is evaluated whether, given the time delay, it is still safe for the user to take the medication. If so, the method returns to step 301. Otherwise, it proceeds to step 313 wherein the user behavior is designated as invalid thereby indicating that the medication has not been taken.

In another example, the combined proximity and motion evaluation may be used to evaluate whether a user has attempted to establish a connection using a short/close range network e.g. on request of an application. This is for example useful for Near Field Communications (NFC) which are aimed at communication ranges of less than typically 10 cm, and specifically where connections are intended to be established by bringing two devices containing the NFC antennas together.

NFC connection establishment is quite sensitive to the duration, orientation and thus antenna alignment, and proximity of the two antennas being brought together when making a connection. E.g. if the user does not hold one NFC enabled device sufficiently close or for long enough to another NFC enabled device, then the connection will not be established.

Similar issues may also be present for other close range networks, such as Bluetooth, body-coupled communication, ANT, or Zigbee, especially when intended for short distances (under 0.5 m). With body-coupled communications, a connection can fail if the user does not touch the second device for long enough (while wearing the first device).

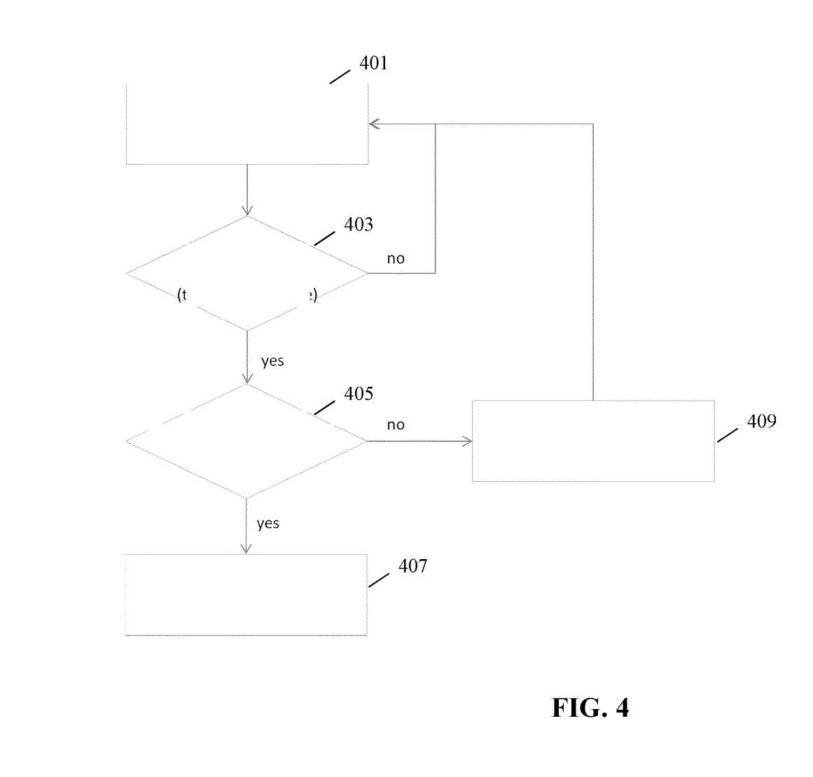

FIG. 4 shows an example of a flow chart for detecting whether the user has attempted to form a short range, and specifically and NFC connection, by bringing two devices close together. For example, if a user has made unsuccessful attempts to form an NFC connection between the first and second device after being requested to do so by an application, the application may proceed to provide guidance to the user. In the examples, attempts are detected by tracking if the second device was significantly moved after the request (measured via motion sensors in the second device). If the user did not make an attempt, then the system could repeat the request, or respect that the user perhaps does not want to make a connection at this moment.

In the example, a person is in step 401 asked by an application to program his NFC enabled smart phone (the second device) by touching it on an external device (the first device). If within a given timeframe (say x seconds) no correct movement was detected and no NFC connection was established, an animation may be shown to guide the user to perform the required action.

Specifically, in step 403, the smart phone (the second device) evaluates whether the motion sensor indicates that the smart phone has been moved consistently with a movement required to form an NFC connection. For example, it may simply require that the smart phone has been moved by more than a given amount. If not, the method returns to step 401. Otherwise, it proceeds to step 405 wherein the smart phone evaluates whether an NFC connection has been established. The establishment of this short range communication is used as an indication of a proximity detection.

If the connection has been made, the method proceeds to step 407 wherein the user action is validated to indicate that the user has performed the required actions to establish the NFC connection. Thus, if the expected motion is detected and then subsequently a proximity is detected in form of the NFC communication link being established, it is considered that a valid user behavior has occurred.

If not, the method proceeds to step 409 wherein the user action is designated as not valid. In the specific example, this option corresponds to a scenario wherein the user is likely to have performed the appropriate movement but this has not resulted in a proximity detection corresponding to the NFC communication being established. Accordingly, the smart phone may in step 409 proceed to provide additional guidance to the user on how to establish an NFC communication. The method may then return to step 401.

Of course, the approach may be further enhanced, e.g. by obtaining more information from sensors of the smart phone in order to diagnose what may have gone wrong. For example the orientation could be wrong so that no alignment of the antennas was achieved. This may e.g. be the case when the user assumed a wrong location of the antenna (e.g. horizontally on the top instead of vertically in the front panel of the external device). Also, the duration of the time that the antennas were aligned could be too short for a full successful transaction. All this kind of extra sensor information could be used so show more detailed instructions and to improve the guidance to the user.

Another specific example is to apply the approach to a payment transaction with a mobile phone. During a payment transaction, the user may be asked to touch the payment terminal with his mobile phone to complete a payment. When the action is not completed, additional (animated) feedback could be given on the display, based on diagnostics of similar sensor inputs as described in the previous example.

In situations where no successful connection was established, possible scenarios may include:
No movement was detected of the mobile phone towards the payment terminal.
A movement has been detected (so it is estimated that the user made an attempt), but no NFC transaction was made.
A movement was detected and the user holds his phone steady (waiting for the transaction to happen). However the orientation (on x,y or z axes) of the device differed to much from to the antenna within the receiving device and both antennas were not aligned properly to power a signal to be transferred.
Part of the NFC transaction took place, however not long enough to complete it.

These scenarios may be differentiated between, e.g. using additional sensor information, and the guidance to the user may be customized accordingly.

In some embodiments, such as e.g. for payment terminals, there is always a certain orientation of the antenna. In this case, the mobile device can judge on its own if the orientation is right. However, if the antenna orientation differs between terminals, the mobile phone preferably knows what type of terminal it is facing to give meaningful feedback. This could be implemented by the user choosing between types on the screen. Otherwise, it may use a second close range wireless technology (e.g. Bluetooth) to allow the mobile device to determine what type of terminal it is facing. (Note that the 10 cm range NFC connection is still meaningful to confirm the payment action).

As yet another example, the approach may be used by a smartphone application to keep track of how often a user brushes his teeth. The user may be required to touch an NFC enabled to a smartphone to indicate that the user has brushed his teeth. If this detection is associated with movement data for the toothbrush which is consistent with the user brushing his teeth within a time interval of, say, 5 minutes prior to the connection being established, the brushing session will be recorded and otherwise it will not.

The approach used by the proximity detector 201 may depend on the specific embodiment and any suitable approach may be used. It is also noted that the approach does not require any specific value or measure for what is considered to be a proximity of the two devices. Indeed, the proximity of the two devices is considered to be defined by the two devices meeting the criterion rather than by any e.g. physical requirement for the two devices.

The proximity criterion may typically be (or comprise) a requirement that an event occurs or a property attains a value which is more probable or likely the closer the devices are to each other.

For example, in some embodiments, the proximity detector 201 may determine that the two devices are proximate in response to a detection of the two devices touching each other. As another example, the proximity detector 201 may determine that the two devices are proximate in response to a camera in one device detecting an image object which matches the second device.

In some embodiments, the proximity detector 201 may be arranged to detect the proximity between the devices in response to an electromagnetic signal radiated from at least one of the devices. For example, if the proximity detector 201 is in the first device 101, it may detect proximity of the second device 103 in response to a radio signal transmitted from the second device 103. Similarly, if the proximity detector 201 is in the second device 103, it may detect proximity of the first device 101 in response to a radio signal transmitted from the first device 101.

In some embodiments, the proximity detection may be in response to the establishment of a communication between the first device 101 and the second device 103. The communication may typically be a close range or short range communication, e.g. the range of the communication system or standard may be no more than 50 cm in many embodiments. The short range communication may for example be a Bluetooth, body-coupled, ANT, or Zigbee communication.

The first device 101 and second device 103 may specifically comprise communication units which are short range communication units, such as specifically NFC communication units. The proximity detector 201 may be arranged to detect the proximity of the second device to the first device in response to an establishment of a communication between the first communication unit and the second communication unit.

Indeed, in many embodiments using short range communication systems, the establishment of a communication link between the two devices is only possible if the two devices are sufficiently close. Thus, the establishment of the communication may in itself be used as an indication of a proximity between the first and second communication units, and thus of the two devices.

For example, the first device 101 and the second device 103 may comprise NFC communication units and associated NFC antennas. If an NFC communication can be established between the two devices, this means that the NFC antennas, and thus the devices, are within typically at least 10 cm of each other. Accordingly, the proximity detector 201 is provided an indication of the establishment of the NFC communication (e.g. by the NFC communication unit of the first device 101 in case the proximity detector 201 is in the first device 101, and by the NFC communication unit of the second device 103 in case the proximity detector 201 is in the second device 103). The proximity detector 201 then determines that a proximity detection has occurred in response to receiving this indication.

In some embodiments, the proximity detector may be arranged to detect the proximity of the second device to the first device in response to a detection of an electromagnetic signal from at least one of the first device and the second device exceeding a detection threshold.

For example, if the first device comprises a Bluetooth transmitter, a proximity detector 201 implemented in the second device 103 may detect the signal level of the Bluetooth transmission from the first device 101. The detected signal level will typically decrease with the distance between the first device 101 and the second device 103, and accordingly if the signal level is sufficiently high, it is likely that the first device 101 is relatively close to the second device 103. The proximity detector 201 may accordingly proceed to monitor the Bluetooth transmission and consider a proximity detection to occur when the signal level rises above a given threshold.

As previously mentioned, the type of motion data and the motion criterion may be selected to meet the requirements and preferences in the individual embodiment.

In some embodiments, a simple motion criterion may be used, such as e.g. a requirement that the absolute movement of the second device 103 exceeds a given amount. In such examples, the motion data may be complex motion data which is processed as part of the evaluation of whether the criterion is met. For example, motion data generated by an accelerometer may be evaluated to determine whether it corresponds to a movement that is higher than a given amount. Alternatively or additionally, the motion data may be simple motion data, such as a single value e.g. indicating the total amount of movement within a given time interval.

In some embodiments, the motion criterion may be a complex requirement defining a set of requirements for the motion to match. Specifically, in many embodiments, the motion criterion may comprise a requirement that the motion data corresponds to a motion pattern. Specifically, the motion criterion may include a requirement that the motion data is indicative of a motion as a function of time with a required accuracy. For example, the pattern may require that the motion data is indicative of a movement having a substantially continuous vertical movement, followed by a short period of substantially no movement, followed by a substantially continuous vertical movement in the opposite direction. The requirement may further specify an acceptable deviation from this motion pattern. Such a specific motion pattern may e.g. be representative of the movement of a user's wrist when taking a pill.

The motion criterion may in many embodiments have a time component. Specifically, in many embodiments, the motion criterion may comprise a requirement that the motion data matches a requirement within a time interval. The time interval may specifically be a relative time interval which is relative to another event. The event may for example be a specific application or external event.

Equivalently, it may be considered that the motion criterion does not include a temporal aspect but that such a spatial motion criterion must be met within a given time interval, such as specifically a time interval from the time of outputting a request for the user to bring the two devices 101, 103 into contact with each other.

For example, in some embodiments, an application may request a user to touch two devices together in order to establish an NFC communication. The motion criterion may then require that the motion data is indicative of a motion corresponding to bringing two devices together within a given time interval of the request. If the motion criterion is not met within the defined time interval, it is assumed that the user has not proceeded to attempt to establish the NFC communication.

Also, in many embodiments, the designator 211 may be arranged to designate the user behavior as valid only if the motion data meets a second motion criterion which comprises a requirement for motion of the second device in a time interval following (and often immediately following) a detection of proximity of the first device to the second device. Thus, in some embodiments, the user behavior is only considered valid if an acceptable movement is detected both before and after the proximity has been detected.

In many embodiments, it may be expected that the second motion criterion requires a motion requirement to be met within a the time interval that is determined relative to the proximity detection. For example, when a smart watch application monitors a user's medication adherence, it may first determine that it is time for the user to take medication. The application may then start monitoring for a user movement of the smart watch towards the pill box and subsequently for a proximity of the smart watch to the pill box. When this proximity is detected, the detection may start a time interval within which the motion data must meet the second motion criterion corresponding to the user movement when taking a pill. If the motion criterion is not met within the time interval, it may be concluded that the user has not taken the pill (and thus the user behavior of pill taking is considered invalid).

In some embodiments, the motion data may comprise orientation data which is indicative of an orientation of the second device and the motion criterion may include a requirement that the orientation data meets a criterion.

Thus, in many embodiments, it may not only be the movement of the whole device which is considered but also (or in some embodiments only) how the device is orientated. The orientation data may specifically be indicative of an absolute or relative rotation of the device. The rotation may be with respect to any desired axis or axes. Also, the orientation data may be relative to the device itself (i.e. it may reflect how the device is rotated as a function of time) or may e.g. be relative to another device, or may be relative to any other axis, such as for example relative to a horizontal or vertical direction.

For some applications, the orientation of the device(s) may be highly significant. The second device 103 (and possibly the first device 101) may accordingly provide motion data that is indicative of the orientation of the device, such as for example it may be indicative of which end of the device is highest (e.g. it may indicate whether the device is upside down or not). Such data may for example be determined by accelerometers or GPS receivers in different parts of the device together with firmware being arranged to calculate orientations from the provided data. As a simple example, a gravity sensor may be used to determine which part of the device is highest.

The orientation may for example be particularly relevant for scenarios wherein a communication is to be established by bringing two antennas of a short range communication system close together. For example, an NFC antenna may be positioned at the top of a mobile phone and at the bottom of another mobile phone with which the first mobile phone is seeking to establish an NFC connection. The user may be requested to establish the NFC connection by turning his phone upside down and putting it on top of the second mobile phone. The motion data for the mobile phone may be arranged to include data that not only reflects how the mobile phone is moved as a whole but also how it is rotated. The motion criterion may accordingly reflect a requirement that the motion data should be consistent with a 180 degree rotation of the mobile phone. If this has not been performed, the user behavior may be considered as not valid and in response the mobile phone may e.g. provide additional user guidance, such as for example by a short animated movie showing a mobile phone being turned upside down and being brought into contact with another mobile phone.

In some embodiments, the apparatus may comprise a controller for determining a time interval during which the motion data must meet the criterion and possibly the proximity of the external device must be detected for the user behavior to be designated valid.

Thus, in some embodiments, the meeting of the motion criterion may be required to occur within a given time interval, and optionally it may also be required that the proximity is subsequently detected within the given time interval. For example, for the medication adherence example, it may be required that the required movement is first detected and that that the pill box is subsequently detected (and in many embodiments that the second motion criterion is met) within a given interval where the interval corresponds to an acceptable time for the user to take the pill. For example, if a user is required to take a pill every, say, six hours, the smart phone may require that the detection of the pill box and the performance of the movement before and after the detection must at the earliest occur, say, 30 minutes before and at the latest, say, 60 minutes after the optimum time for the user to take the pill. In such cases, the smart phone may e.g. provide a warning notice to the user if detections occur earlier than 30 minutes before or have not occurred 60 minutes after the optimum time.

In some embodiments, the time interval may be determined relative to a timer. For example, a timer may be set to count down since the last valid user action was detected and when the timer times out, the controller may start the time interval with e.g. a predetermined duration.

In other examples, the time interval may be determined relative to a potentially asynchronous or unpredictable event. For example, the user may at a random time start an application on a smartphone and this application may at some stage require an NFC connection to be established. In response, it may request the user to establish an NFC connection and at the same time it may initialize a time interval in which the other device must be detected and the user movement(s) be performed. If this does not occur within the time interval, the smart phone may for example proceed to provide further guidance or may e.g. decide to proceed with the application without the use of an NFC connection (e.g. by providing reduced functionality).

The approach may in many embodiments be particularly suitable for providing customized user output particularly adapted to the use scenario and the user's behavior.

In some embodiments, the apparatus may be arranged to provide a user notification which is dependent on whether the user behavior is validated or not. Furthermore, if the user behavior is not validated, the user notification may be dependent on whether the proximity detection occurred but the motion data did not meet the motion criterion; whether the proximity detection did not occur but the motion data met the motion criterion; or whether the proximity detection did not occur and the motion data did not meet the motion criterion.

In some embodiments, the apparatus may comprise a user interface for generating a user output in response to whether the proximity of the first device to the second device is detected within a given time interval. The user interface may generate different user feedback/notifications for the situation where the proximity is detected within the time interval than when is not.

For example, in the previous example of bringing two devices together to establish an NFC connection, the establishment of this may be considered to correspond to a proximity detection. Thus, if communication is established within the time interval, the user interface may generate user feedback confirming this. If no communication is established within the time interval, the user notification may instead indicate that an error has occurred and request the user to repeat the attempt.

As another example, in some embodiments, the apparatus may comprise a user interface which is arranged to generate different user notifications if the motion data meets the motion criterion within a given time interval but no proximity of the second device to the first device is detected than if the motion data does not meet the motion criterion within the time interval.

For example, a user may use two devices that are intended to be brought together to form an NFC connection. One of the devices may comprise a display which requests the user to bring the two devices together. It may then start a time interval in which it is expected that the user will establish an NFC connection by bringing these together. The successful establishment of an NFC connection is considered to be a proximity detection for the two devices.

Accordingly, if no NFC connection is established within the given time interval, the user behavior is considered to not be valid. However, the user feedback may be dependent on the determination of whether the motion data meets the motion criterion. If so, the device may consider that it is probable that the user attempted to bring the two devices together but failed. Accordingly, it may proceed to generate additional guidance for the user and this guidance may be presented to the user. However, if the user data does not meet the motion criterion, the device may consider that the user has not attempted to make the connection. It may then generate a user notification which reflects this scenario, e.g. by generating a user notification requesting the user to attempt the NFC connection establishment again or by generating a user notification indicating to the user that the device will continue the application without including the functionality associated with the NFC connection link (e.g. generic or default data may be used rather than specific data intended to be provided by the other device via the NFC connection).

In some embodiments, the apparatus of FIG. 2 may include a user interface which is arranged to generate a user notification if the motion data meets the motion criterion within a given time interval but no presence of another device is detected.

In some embodiments, the apparatus further comprises a receiver which is arranged to receive operational data from at least one of the devices. The designator 211 may then be arranged to designate the user behavior as valid only if the operational data meets a criterion.

Thus, in some embodiments, the user behavior is only designated as valid if operational data matches a criterion. The operational data is indicative of the operation and typically the use of the corresponding device. For example, the operational data may be indicative of an operational mode of the device, of whether a specific action has been performed, or of whether a specific event has occurred. In some embodiments, the operational data may be indicative of whether a specific user input, action or event has been detected.

As an example, the apparatus of FIG. 2 may be included in a smartphone corresponding to the second device. The apparatus may further comprise a receiver that receives operational data from the first device which specifically may be a pill box. The operational data from the pill box may for example include an indication of whether the door to the pill box has been opened or not. In this example, the user behavior may only be considered valid if the door to the pill box has been opened.

The criterion for the operational data may be any suitable criterion for the specific embodiment. In many embodiments, the criterion may include a requirement that the operational data is indicative of an event occurring within a given time interval, which may be an absolute or relative time interval.

It will be appreciated that different actions may be taken in dependence on whether the user behavior is designated as valid or not. Indeed, in many embodiments, the apparatus, and specifically one of the first and second devices, is arranged to execute an operation in dependence on whether the user behavior is designated valid or not.

In some embodiments, the outcome of the validation evaluation may simply be stored. For example, in the medical adherence example, the determination of whether the user is likely to have taken his medicine or not may be recorded in order to generate a data record of the user's general adherence to the prescribed intake of medicine.

In some embodiments, the apparatus may be arranged to generate different user inputs in dependence on whether the user behavior is considered valid or not. For example, if not considered valid, the apparatus may generate a user output providing further guidance to the user.

In many embodiments, the apparatus may be arranged to branch a computational process in dependence on whether the user behavior is considered valid or not. For example, the apparatus may execute an application which may call different subroutines or functions depending on whether the user behavior is considered valid or not. In some embodiments, the apparatus may be arranged to start an application based on whether the user behavior is designated valid or not.

As another example, in some embodiments, the apparatus may be arranged to initiate a communication in dependence on whether the user behavior is designated valid or not. For example, if the user behavior is considered valid, no action may be taken in the medication monitoring example as it is considered that the user has taken the medicine as prescribed. However, if the user behavior is not designated as valid, the apparatus may initiate a communication to a remote device to alert that the medicine is presumed not to be taken.

Indeed, a particularly suitable application area for the approach may be the monitoring of the ill, weak or elderly. For example, it may be expected that a home patient performs a specific user behavior every day. If the apparatus detects that a valid expected user behavior has not been detected e.g. during a day, it may establish a communication to a remote device which may alert remote help staff to the possibility that the user may need assistance.

In the previous examples, the user behavior was designated as valid based on motion data for only one of the first and second devices. However, in some embodiments, the motion data may comprise motion data for both the first and the second devices, and the motion criterion may comprise requirements for motion data of both the first and second devices.

The motion data may for example be orientation/rotation data for two mobile devices. E.g. when an NFC connection is to be established between two mobile devices, it may be necessary for the two devices to be oriented correctly with respect to each other in order for the NFC antennas of the two devices to be sufficiently close to each other to obtain optimal connection.

In such a case, orientation data for both devices may be obtained. Furthermore, the establishment of the NFC connection may be considered to provide a proximity detection. In addition, the motion criterion may require that the orientation data for the two devices match a scenario where the two devices are oriented correctly with respect to each other. If so, the user behavior is considered valid and the application may proceed using the NFC connection. However, if not, the NFC connection is maintained but the user is provided with a request to change the orientation of the two devices to achieve a better alignment of the NFC antennas. The application may then proceed as when the user behavior is designated valid.

As previously mentioned, the different functions may be implemented in different devices, including the first device 101, the second device 103, or indeed one or more other devices.

However, in many embodiments, it is particularly advantageous for the functionality evaluating the user behavior to be comprised in the device on whose movement the evaluation is based, i.e. in the second device 103. Thus, in many embodiments, the second device not only comprises a motion sensor for generating the motion data but also comprises the proximity detector 201, the receiver 203, the evaluator 209 and the designator 211.

This may for example allow the user to use his own device to evaluate the user behavior. For example, in the medical adherence example, essentially all functionality may be comprised in the smart watch and the only requirement for the pill box may be that the proximity of this can be detected.

The approach of implementing the functionality in the user moveable device which is used for evaluation may allow many advantageous applications. In particular, it may allow the user's own device to evaluate user behavior without, in many scenarios, requiring the other device to have any knowledge of this evaluation. For example, it may only require that the other device comprises NFC functionality for establishing an NFC communication and perhaps identifying itself The approach may allow for significant customization and adaptation to the user's specific preferences and requirements.

In many embodiments, it may also be particularly advantageous for the functionality evaluating the user behavior to be comprised in a device other than the one on whose movement the evaluation is based. In particular, it may be advantageous for the functionality to be included in the other device being involved in the proximity detection, i.e. in the first device 101. Thus, in many embodiments, the first device 101 may comprise the proximity detector 201, the receiver 203, the evaluator 209 and the designator 211.

This may in particular allow generic devices to be used with many different users, each of which have their own device. Indeed, it may allow stationary devices to evaluate the user behavior in line with the described principles. For example, a generic payment terminal may comprise all the functionality for evaluating the user behavior. It may receive motion data from another device it is coupled to via NFC, and this motion data may then be used to evaluate the user behavior. Thus, the payment terminal can be used with any e.g. smart phone running a suitable application that is arranged to provide the motion data.

As another example, a tooth brush may transmit motion data to a smart phone when coupled via NFC, and this motion data may be used to confirm that e.g. a tooth brushing activity has been sufficient (e.g. has been performed for long enough).

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc. do not preclude a plurality. Also, references to first, second etc. are merely to be considered as labels and do not imply or describe any ordering, sequence, relation or properties of the features prefixed by these terms. Reference signs in the claims are provided merely as a clarifying example shall not be construed as limiting the scope of the claims in any way.

1. An apparatus for validating a user behavior; the apparatus comprising:
a proximity detector for detecting a proximity of a first device to a second device;
a receiver for receiving motion data from a motion detector, the motion data being indicative of a motion of the second device;
an evaluator for evaluating if the motion data meets a motion criterion;
a designator for designating the user behavior as valid only if the motion data meets the motion criterion and the proximity of the first device to the second device is subsequently detected; and
a user interface for generating a user output in response to whether the motion data meets the motion criterion within a given time interval or not.

2. The apparatus of claim 1 wherein the first device and the second device comprises communication units; and the proximity detector is arranged to detect the proximity of the first device to the second device in response to an establishment of a communication between the communication units.

3. The apparatus of claim 1 wherein the second device comprises a motion sensor for generating the motion data, and the second device further comprises the proximity detector, the receiver, the evaluator and the designator.

4. The apparatus of claim 1 wherein the first device comprises the proximity detector, the receiver, the evaluator and the designator.

5. The apparatus of claim 1 further comprising a user output for outputting a request for a user to perform a user action to bring the first device into proximity with the second device; and wherein the evaluator is arranged to determine the motion criterion as a motion criterion associated with the user action.

6. The apparatus of claim 5 wherein the designator is arranged to designate the user behavior as valid only if the motion data meets the motion criterion within a first time interval relative to a timing of outputting the request.

7. The apparatus of claim 1 further comprising a user interface for generating a user output in response to whether proximity of the first device to the second device is detected within a given time interval.

8. The apparatus of claim 1 wherein the motion criterion comprises a requirement of the detection of the proximity of the first device to the second device occurring within a time interval relative to the motion data corresponding to a motion pattern of the second device.

9. The apparatus of claim 1 further comprising a controller for determining a time interval in which the motion data must meet the motion criterion, and the proximity of the first device to the second device must be detected for the user behavior to be designated valid.

10. The apparatus of claim 9 further comprising a user interface arranged to generate a user notification if the motion data meets the motion criterion within the time interval but no proximity of the first device to the second device is detected.

11. The apparatus of claim 1 further comprising a receiver for receiving operational data from at least one of the first device and the second device, and wherein the designator is arranged to designate the user behavior as valid only if the operational data meets a criterion.

12. The apparatus of claim 1 wherein the motion data comprises orientation data indicative of an orientation of at least one of the first device and the second device; and the motion criterion includes a requirement that the orientation data meets a criterion.

13. The apparatus of claim 1 wherein the designator is further arranged to designate the user behavior as valid only if the motion data meets a further motion criterion comprising a requirement for motion of the second device in a time interval following a detection of proximity of the first device to the second device.

14. The apparatus of claim 1 wherein the motion data is indicative of a motion of both the first device and the second device and the motion criterion comprises a requirement for motion of the first device and motion of the second device.

15. A method of validating a user behavior; the method comprising:
detecting a proximity of a first device to a second device
receiving motion data from a motion detector, the motion data being indicative of a motion of the second device;
evaluating if the motion data meets a motion criterion; and
designating the user behavior as valid only if the motion data meets the motion criterion and the proximity of the first device to the second device is subsequently detected;
generating a user output in response to whether the motion data meets the motion criterion within a given time interval.
